(19) United States
(12) Patent Application Publication
(10) Pub. No.: US 2016/0221683 A1
(43) Pub. Date: Aug. 4, 2016

(54) Hybrid Power Systems for Vehicle with Hybrid Flight Modes

(71) Applicant: Google Inc., Mountain View, CA (US)

(72) Inventors: John Roberts, Mountain View, CA (US); Abe Bachrach, Mountain View, CA (US); James Ryan Burgess, Mountain View, CA (US)

(73) Assignee: Google Inc., Mountain View, CA (US)

(21) Appl. No.: 14/281,558

(22) Filed: May 19, 2014

(51) Int. Cl. B64D 31/06

(52) U.S. Cl. CPC B64D 31/06

(57) ABSTRACT

Embodiments described herein may relate to methods and systems for supplying auxiliary power to an unmanned aerial vehicle (UAV) with different flight modes. In particular, the system may determine that a UAV is operating in a first flight mode. Responsively, the system may cause the UAV to draw power from a first power source at a first power level while operating in the first flight mode. Subsequently, the system may determine that the UAV switched from operating in the first flight mode to operating in a second flight mode. Responsively, the system may cause the UAV, while operating in the second flight mode, to continue drawing power from the first power source at the first power level and draw power from a second power source at a second power level, where the UAV consumes power at a higher rate during the second flight mode than during the first flight mode.

### BACKGROUND

An unmanned vehicle, which may also be referred to as an autonomous vehicle, is a vehicle capable of travel without a physically-present human operator. An unmanned vehicle may operate in a remote-control mode, in an autonomous mode, or in a partially autonomous mode.

When an unmanned vehicle operates in a remote-control mode, a pilot or driver that is at a remote location can control the unmanned vehicle via commands that are sent to the unmanned vehicle via a wireless link. When the unmanned vehicle operates in autonomous mode, the unmanned vehicle typically moves based on pre-programmed navigation waypoints, dynamic automation systems, or a combination of these. Further, some unmanned vehicles can operate in both a remote-control mode and an autonomous mode, and in some instances may do so simultaneously. For instance, a remote pilot or driver may wish to leave navigation to an autonomous system while manually performing another task, such as operating a mechanical system for picking up objects, as an example.

Various types of unmanned vehicles exist for various different environments. For instance, unmanned vehicles exist for operation in the air, on the ground, underwater, and in space. Examples include quad-copters and tail-sitter UAVs, among others. Unmanned vehicles also exist for hybrid operations in which multi-environment operation is possible. Examples of hybrid unmanned vehicles include an amphibious craft that is capable of operation on land as well as on water or a floatplane that is capable of landing on water as well as on land. Other examples are also possible.

### SUMMARY

Embodiments described herein may relate to methods and systems for supplying auxiliary power to an unmanned aerial vehicle (UAV) with different flight modes. In particular, the system (e.g., a control system) may determine that a UAV is operating in a forward-flight mode. Responsively, the system may cause the UAV to draw power from a primary power source at a constant optimized power level while operating in the forward-flight mode. Subsequently, the system may determine that the UAV switched from operating in the forward-flight mode to operating in a hover-flight mode. Responsively, the system may cause the UAV, while operating in the hover-flight mode, to continue drawing power from the primary power source at the constant optimized power level as well as draw power from an auxiliary power source at a determined power level. The UAV may consume power at a higher rate during the hover-flight mode than during the forward-flight mode.

In one aspect, a system is provided. The system includes a first power source for an unmanned aerial vehicle (UAV). The system also includes a second power source configured to supply auxiliary power for the UAV. The system further includes a control system configured to perform functions. The functions include determining that the UAV is operating in a first flight mode, and responsively causing the UAV to draw power from the first power source at a first power level while operating in the first flight mode. The functions also include determining that the UAV switched from operating in the first flight mode to operating in a second flight mode, and responsively causing the UAV, while operating in the second flight mode, to (i) continue drawing power from the first power source at the first power level and (ii) draw power from the second power source at a second power level, where the UAV consumes power at a higher rate during the second flight mode than during the first flight mode.

In another aspect, a method is provided. The method involves determining that a UAV is operating in a first flight mode. The method also involves, in response to the determination that the UAV is operating in the first flight mode, causing the UAV to draw power from the first power source at a first power level while operating in the first flight mode. The method additionally involves determining that the UAV switched from operating in the first flight mode to operating in a second flight mode. The method further involves, in response to the determination that the UAV switched from operating in the first flight mode to operating in a second flight mode, causing the UAV, while operating in the second flight mode, to (i) continue drawing power from the first power source at the first power level and (ii) draw power from the second power source at a second power level, where the UAV consumes power at a higher rate during the second flight mode than during the first flight mode.

In yet another aspect, a non-transitory computer readable medium is provided. The non-transitory computer readable medium has stored therein instructions executable by a control system to cause the control system device to perform functions. The functions include determining that a UAV is operating in a first flight mode. The functions also include, in response to the determination that the UAV is operating in the first flight mode, causing the UAV to draw power from the first power source at a first power level while operating in the first flight mode. The functions additionally include determining that the UAV switched from operating in the first flight mode to operating in a second flight mode. The functions further include, in response to the determination that the UAV switched from operating in the first flight mode to operating in a second flight mode, causing the UAV, while operating in the second flight mode, to (i) continue drawing power from the first power source at the first power level and (ii) draw power from the second power source at a second power level, where the UAV consumes power at a higher rate during the second flight mode than during the first flight mode.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIGS. 1, 2, 3A, and 3B are simplified illustrations of unmanned aerial vehicles, according to example embodiments.

FIG. 4 is a simplified block diagram illustrating a UAV system, according to an example embodiment.

FIG. 5 is a simplified block diagram illustrating components of an unmanned aerial vehicle, according to an example embodiment.

FIG. 6A is a simplified block diagram illustrating components of a power system, according to an example embodiment.

FIG. 6B is a simplified block diagram illustrating components of an alternative implementation of the power system, according to an example embodiment.

FIG. 7 is an example flowchart for supplying auxiliary power, according to an example embodiment.

### DETAILED DESCRIPTION

The following detailed description describes various features and functions of the disclosure with reference to the accompanying Figures. In the Figures, similar symbols typically identify similar components, unless context dictates otherwise. The illustrative systems described herein are not meant to be limiting. It will be readily understood that certain aspects of the disclosure can be arranged and combined in a wide variety of different configurations, all of which are contemplated herein.

### I. Overview

Embodiments described herein may relate to and/or may be implemented in a system in which unmanned vehicles, and in particular, “unmanned aerial vehicles” (UAVs) with different flight modes, may include an auxiliary power source configured to supply power to the UAV during flight modes with higher power draws. More specifically, the UAV may be configured to operate in a forward-flight mode and in a hover-flight mode.

Typically, the longer a flight is, the larger the portion of the flight that is spent in a forward-flight mode (and correspondingly, the smaller the portion of the flight that is spent in a hover-flight mode). However, hover flight may involve a higher power requirement than forward flight because a significant portion of the required lift in forward flight may be generated via the wing rather than directly via thrust. In particular, hover flight may result in a higher power draw (e.g., peak power consumption lasting for a specific time period) than forward flight. In this case, a single power source may not be enough to withstand such a power draw.

An auxiliary power source may be desirable to provide a boost of power in certain phases of flight (such as hover flight) that result in higher power draws. Additionally, an auxiliary power source may also be desirable to avoid damage to the primary power source of the UAV. For example, higher power draws for batteries with certain chemistries may result in damage and/or a shorter life span for the battery and may therefore require frequent replacement of the primary power source. As a result, having a smaller and easily replaceable auxiliary power source for higher power draws may reduce the cost of replacement.

In other words, the UAV may include at least one primary power source, which may be used during the UAV's flight modes that involve lower power draws (e.g. forward-flight mode), and may include at least one auxiliary power source, which may be used to supplement (and/or replace) the primary power source during phases of flight that involve higher power draws (e.g., hover-flight mode). This may help prevent damage to the primary power source.

Note that the auxiliary power source may also be used for other phases of flight (or maneuvers) that result in a higher power draws (e.g., higher power draws than forward-flight mode) such as acceleration, turning, climbing in altitude, stopping at hover, takeoff, and landing, among other possibilities. Further, note that the UAV may include multiple auxiliary power sources where any combination of the multiple auxiliary power sources may be used for any of the phases of the UAV's flight. Other examples and combinations may also be possible.

In an example embodiment, the primary power source and the auxiliary power source may be different power sources such as a gas turbine and a battery or two different batteries. In one example, a gas turbine may be used as the primary power source for forward-flight mode and a battery may be used as an auxiliary power source for hover-flight mode. Such a configuration may take advantage of the different specific energy densities of fuel versus batteries due to gas's higher specific energy density.

In another example, a battery with a specific type of chemistry (e.g., Lithium Ion or Lithium Polymer) may be used as the primary power source for forward-flight mode. In particular, a battery type to be used as the primary power source may be selected based on various factors such as efficiency and weight, among others. A battery with a different type of chemistry (e.g., Nickel Cadmium) may then be used as the auxiliary power source for hover-flight mode. In particular, a battery type to be used as the auxiliary power source may be selected based on various factors such as cost and utilization for higher power draws, among others. In another case, batteries of the same type may be used. Other combinations of power sources may also be possible.

The primary power source and the auxiliary power source may be placed on the UAV in any configuration. For example, the UAV may have a single set of rotors with the multiple power sources on a single powertrain. Additionally, the power sources may be controlled by a control system that is configured to determine that the UAV is operating at a particular flight mode (e.g., hover-flight mode). The control system may then be configured to activate (or deactivate) the auxiliary power source based on the flight mode's power consumption. Other configuration may also be possible.

### II. Illustrative Unmanned Vehicles

Herein, the terms “unmanned aerial vehicle” and “UAV” refer to any autonomous or semi-autonomous vehicle that is capable of performing some functions without a physically-present human pilot. Examples of flight-related functions may include, but are not limited to, sensing its environment or operating in the air without a need for input from an operator, among others.

A UAV may be autonomous or semi-autonomous. For instance, some functions could be controlled by a remote human operator, while other functions are carried out autonomously. Further, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from the city hall in Palo Alto to the city hall in San Francisco), while the UAV's navigation system autonomously controls more fine-grained navigation decisions, such as the specific route to take between the two locations, specific flight controls to achieve the route and avoid obstacles while navigating the route, and so on. Other examples are also possible.

A UAV can be of various forms. For example, a UAV may take the form of a rotorcraft such as a helicopter or multicopter, a fixed-wing aircraft, a jet aircraft, a ducted fan aircraft, a lighter-than-air dirigible such as a blimp or steerable balloon, a tail-sitter aircraft, a glider aircraft, and/or an ornithopter, among other possibilities. Further, the terms “drone”, “unmanned aerial vehicle system” (“UAVS”), or “unmanned aerial system” (“UAS”) may also be used to refer to a UAV.

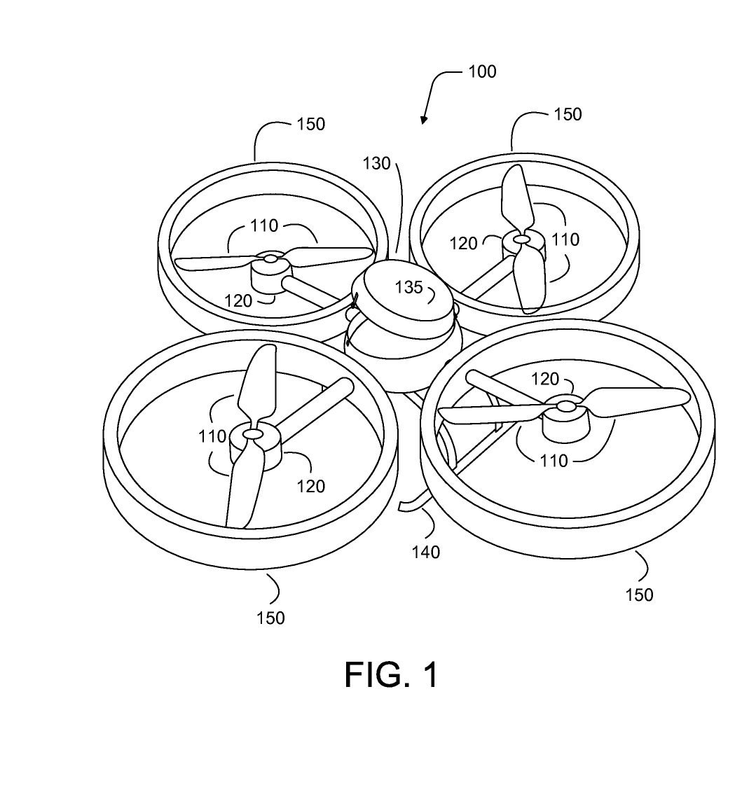

FIG. 1 is a simplified illustration of a UAV, according to an example embodiment. In particular, FIG. 1 shows an example of a rotorcraft 100 that is commonly referred to as a multicopter. Multicopter 100 may also be referred to as a quadcopter, as it includes four rotors 110. It should be understood that example embodiments may involve rotorcraft with more or less rotors than multicopter 100. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to multicopter 100 in greater detail, the four rotors 110 provide propulsion and maneuverability for the multicopter 100. More specifically, each rotor 110 includes blades that are attached to a motor 120. Configured as such the rotors may allow the multicopter 100 to take off and land vertically, to maneuver in any direction, and/or to hover. Furthermore, the pitch of the blades may be adjusted as a group and/or differentially, and may allow a multicopter 100 to perform three-dimensional aerial maneuvers such as an upside-down hover, a continuous tail-down “tic-toc,” loops, loops with pirouettes, stall-turns with pirouette, knife-edge, immelmann, slapper, and traveling flips, among others. When the pitch of all blades is adjusted to perform such aerial maneuvering, this may be referred to as adjusting the “collective pitch” of the multicopter 100. Blade-pitch adjustment may be particularly useful for rotorcraft with substantial inertia in the rotors and/or drive train, but is not limited to such rotorcraft.

Additionally or alternatively, multicopter 100 may propel and maneuver itself adjust the rotation rate of the motors, collectively or differentially. This technique may be particularly useful for small electric rotorcraft with low inertia in the motors and/or rotor system, but is not limited to such rotorcraft.

Multicopter 100 also includes a central enclosure 130 with a hinged lid 135. The central enclosure may contain, e.g., control electronics such as an inertial measurement unit (IMU) and/or an electronic speed controller, batteries, other sensors, and/or a payload, among other possibilities.

The illustrative multicopter 100 also includes landing gear 140 to assist with controlled take-offs and landings. In other embodiments, multicopters and other types of UAVs without landing gear are also possible.

In a further aspect, multicopter 100 includes rotor protectors 150. Such rotor protectors 150 can serve multiple purposes, such as protecting the rotors 110 from damage if the multicopter 100 strays too close to an object, protecting the multicopter 100 structure from damage, and protecting nearby objects from being damaged by the rotors 110. It should be understood that in other embodiments, multicopters and other types of UAVs without rotor protectors are also possible. Further, rotor protectors of different shapes, sizes, and function are possible, without departing from the scope of the invention.

A multicopter 100 may control the direction and/or speed of its movement by controlling its pitch, roll, yaw, and/or altitude. To do so, multicopter 100 may increase or decrease the speeds at which the rotors 110 spin. For example, by maintaining a constant speed of three rotors 110 and decreasing the speed of a fourth rotor, the multicopter 100 can roll right, roll left, pitch forward, or pitch backward, depending upon which motor has its speed decreased. Specifically, the multicopter may roll in the direction of the motor with the decreased speed. As another example, increasing or decreasing the speed of all rotors 110 simultaneously can result in the multicopter 100 increasing or decreasing its altitude, respectively. As yet another example, increasing or decreasing the speed of rotors 110 that are turning in the same direction can result in the multicopter 100 performing a yaw-left or yaw-right movement. These are but a few examples of the different types of movement that can be accomplished by independently or collectively adjusting the RPM and/or the direction that rotors 110 are spinning.

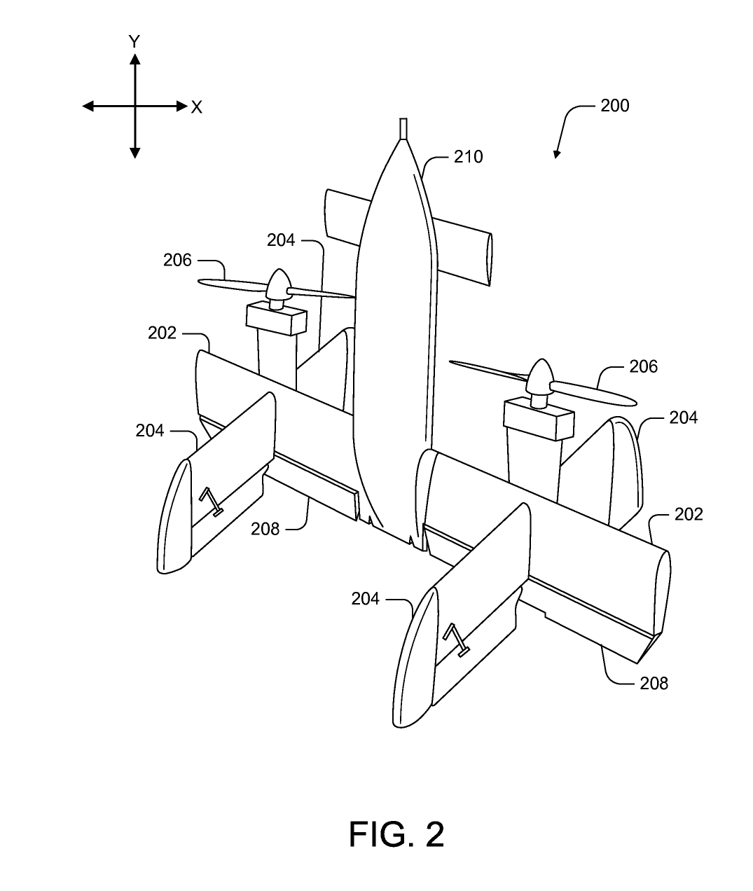

FIG. 2 is a simplified illustration of a UAV, according to an example embodiment. In particular, FIG. 2 shows an example of a tail-sitter UAV 200. In the illustrated example, the tail-sitter UAV 200 has fixed wings 202 to provide lift and allow the UAV to glide horizontally (e.g., along the x-axis, in a position that is approximately perpendicular to the position shown in FIG. 2). However, the fixed wings 202 also allow the tail-sitter UAV 200 take off and land vertically on its own.

For example, at a launch site, tail-sitter UAV 200 may be positioned vertically (as shown) with fins 204 and/or wings 202 resting on the ground and stabilizing the UAV in the vertical position. The tail-sitter UAV 200 may then take off by operating propellers 206 to generate the upward thrust (e.g., a thrust that is generally along the y-axis). Once at a suitable altitude, the tail-sitter UAV 200 may use its flaps 208 to reorient itself in a horizontal position, such that the fuselage 210 is closer to being aligned with the x-axis than the y-axis. Positioned horizontally, the propellers 206 may provide forward thrust so that the tail-sitter UAV 200 can fly in a similar manner as a typical airplane.

Variations on the illustrated tail-sitter UAV 200 are possible. For instance, tail-sitters UAVs with more or less propellers, or that utilize a ducted fan or multiple ducted fans, are also possible. Further, different wing configurations with more wings (e.g., an “x-wing” configuration with four wings), with less wings, or even with no wings, are also possible. More generally, it should be understood that other types of tail-sitter UAVs and variations on the illustrated tail-sitter UAV 200 are also possible.

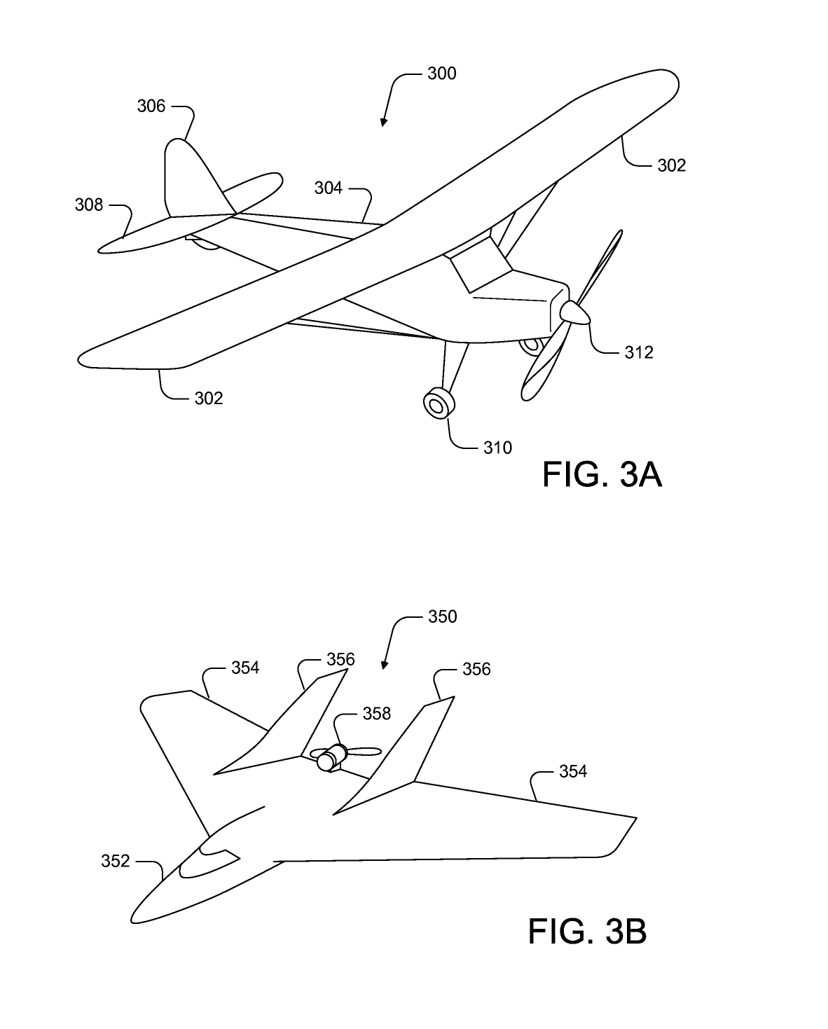

As noted above, some embodiments may involve other types of UAVs, in addition or in the alternative to multicopters. For instance, FIGS. 3A and 3B are simplified illustrations of other types of UAVs, according to example embodiments.

In particular, FIG. 3A shows an example of a fixed-wing aircraft 300, which may also be referred to as an airplane, an aeroplane, or simply a plane. A fixed-wing aircraft 300, as the name implies, has stationary wings 302 that generate lift based on the wing shape and the vehicle's forward airspeed. This wing configuration is different from a rotorcraft's configuration, which produces lift through rotating rotors about a fixed mast, and an ornithopter's configuration, which produces lift by flapping wings.

FIG. 3A depicts some common structures used in a fixed-wing aircraft 300. In particular, fixed-wing aircraft 300 includes a fuselage 304, two horizontal wings 302 with an airfoil-shaped cross section to produce an aerodynamic force, a vertical stabilizer 306 (or fin) to stabilize the plane's yaw (turn left or right), a horizontal stabilizer 308 (also referred to as an elevator or tailplane) to stabilize pitch (tilt up or down), landing gear 310, and a propulsion unit 312, which can include a motor, shaft, and propeller.

FIG. 3B shows an example of an aircraft 350 with a propeller in a pusher configuration. The term “pusher” refers to the fact that the propulsion unit 358 is mounted at the back of the aircraft and “pushes” the vehicle forward, in contrast to the propulsion unit being mounted at the front of the aircraft. Similar to the description provided for FIG. 3A, FIG. 3B depicts common structures used in the pusher plane: a fuselage 352, two horizontal wings 354, vertical stabilizers 356, and a propulsion unit 358, which can include a motor, shaft, and propeller.

UAVs can be launched in various ways, using various types of launch systems (which may also be referred to as deployment systems). A very simple way to launch a UAV is a hand launch. To perform a hand launch, a user holds a portion of the aircraft, preferably away from the spinning rotors, and throws the aircraft into the air while contemporaneously throttling the propulsion unit to generate lift.

Rather than using a hand launch procedure in which the person launching the vehicle is exposed to risk from the quickly spinning propellers, a stationary or mobile launch station can be utilized. For instance, a launch system can include supports, angled and inclined rails, and a backstop. The aircraft begins the launch system stationary on the angled and inclined rails and launches by sufficiently increasing the speed of the propeller to generate forward airspeed along the incline of the launch system. By the end of the angled and inclined rails, the aircraft can have sufficient airspeed to generate lift. As another example, a launch system may include a rail gun or cannon, either of which may launch a UAV by thrusting the UAV into flight. A launch system of this type may launch a UAV quickly and/or may launch a UAV far towards the UAV's destination. Other types of launch systems may also be utilized.

In some cases, there may be no separate launch system for a UAV, as a UAV may be configured to launch itself. For example, a “tail sitter” UAV typically has fixed wings to provide lift and allow the UAV to glide, but also is configured to take off and land vertically on its own. Other examples of self-launching UAVs are also possible.

In a further aspect, various other types of unmanned vehicles may be utilized to provide remote medical support. Such vehicles may include, for example, unmanned ground vehicles (UGVs), unmanned space vehicles (USVs), and/or unmanned underwater vehicles (UUVs). A UGV may be a vehicle which is capable of sensing its own environment and navigating surface-based terrain without input from a driver. Examples of UGVs include watercraft, cars, trucks, buggies, motorcycles, treaded vehicles, and retrieval duck decoys, among others. A UUV is a vehicle that is capable of sensing its own environment and navigating underwater on its own, such as a submersible vehicle. Other types of unmanned vehicles are possible as well.

### III. Illustrative UAV Systems

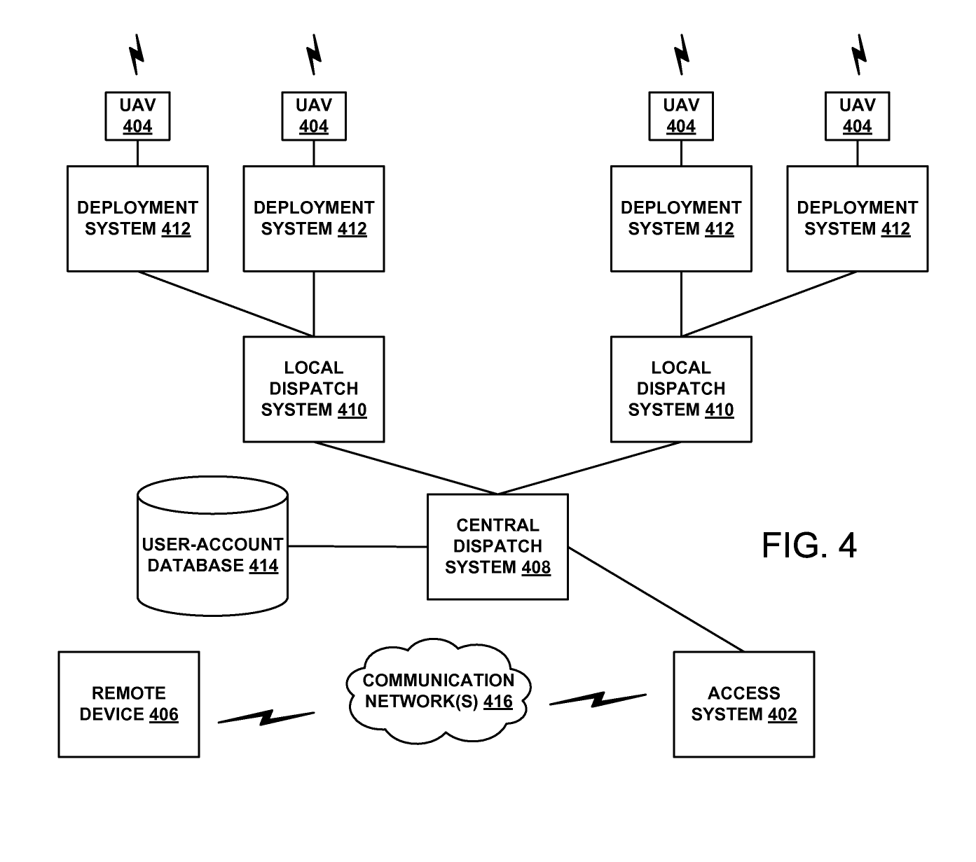

UAV systems may be implemented in order to provide various services. In particular, UAVs may be provided at a number of different launch sites, which may be in communication with regional and/or central control systems. Such a distributed UAV system may allow UAVs to be quickly deployed to provide services across a large geographic area (e.g., that is much larger than the flight range of any single UAV). For example, UAVs capable of carrying payloads may be distributed at a number of launch sites across a large geographic area (possibly even throughout an entire country, or even worldwide), in order to deliver various items to locations throughout the geographic area. As another example, a distributed UAV system may be provided in order to provide remote medical support, via UAVs. FIG. 4 is a simplified block diagram illustrating a distributed UAV system 400, according to an example embodiment.

In an illustrative UAV system 400, an access system 402 may allow for interaction with, control of, and/or utilization of a network of UAVs 404. In some embodiments, an access system 402 may be a computing system that allows for human-controlled dispatch of UAVs 404. As such, the control system may include or otherwise provide a user interface (UI) via which a user can access and/or control UAVs 404. In some embodiments, dispatch of UAVs 404 may additionally or alternatively be accomplished via one or more automated processes.

Further, an access system 402 may provide for remote operation of a UAV. For instance, an access system 402 may allow an operator to control the flight of a UAV via user interface (UI). As a specific example, an operator may use an access system to dispatch a UAV 404 to deliver a package to a target location, or to travel to the location of a medical situation with medical-support items. The UAV 404 may then autonomously navigate to the general area of the target location. At this point, the operator may use the access system 402 to take over control of the UAV 404, and navigate the UAV to the target location (e.g., to a particular person to whom a package is being sent). Other examples of remote operation of a UAV are also possible.

In an illustrative embodiment, UAVs 404 may take various forms. For example, each UAV 404 may be a UAV such as those illustrated in FIGS. 1, 2, 3A, and 3B. However, UAV system 400 may also utilize other types of UAVs without departing from the scope of the invention. In some implementations, all UAVs 404 may be of the same or a similar configuration. However, in other implementations, UAVs 404 may include a number of different types of UAVs. For instance, UAVs 404 may include a number of types of UAVs, with each type of UAV being configured for a different type or types of medical support.

A remote device 406 may take various forms. Generally, a remote device 406 may be any device via which a direct or indirect request to dispatch UAV can be made. (Note that an indirect request may involve any communication that may be responded to by dispatching a UAV; e.g., requesting a package delivery, or sending a request for medical support). In an example embodiment, a remote device 406 may be a mobile phone, tablet computer, laptop computer, personal computer, or any network-connected computing device. Further, in some instances, remote device 406 may not be a computing device. As an example, a standard telephone, which allows for communication via plain old telephone service (POTS), may serve as a remote device 406. Other types of remote devices are also possible.

Further, a remote device 406 may be configured to communicate with access system 402 via one or more types of communication network(s) 416. For example, a remote device 406 could communicate with access system 402 (or via a human operator of the access system) by placing a phone call over a POTS network, a cellular network, and/or a data network such as the Internet. Other types of networks may also be utilized.

In some embodiments, a remote device 406 may be configured to allow a user to request delivery of one or more items to a desired location. For example, a user could request UAV delivery of a package to their home via their mobile phone, tablet, or laptop. As another example, a user could request dynamic delivery to whatever location they are at at the time of delivery. To provide such dynamic delivery, a UAV system 400 may receive location information (e.g., GPS coordinates, etc.) from the user's mobile phone, or any other device on the user's person, such that a UAV can navigate to the user's location (as indicated by their mobile phone).

In some embodiments, a remote device 406 may be configured to allow a user to request medical support. For example, a person may use their mobile phone, a POTS phone, or a VoIP phone, to place an emergency call (e.g., a 9-1-1 call) and request that medical support be provided at the scene of an accident. Further, note that a request for medical support need not be explicit. For instance, a person may place a 9-1-1 call to report an emergency situation. When the 9-1-1 operator receives such a call, the operator may evaluate the information that is provided and decide that medical support is appropriate. Accordingly, the operator may use an access system 402 to dispatch a UAV 404.

As noted, a remote device 406 may be configured to determine and/or provide an indication of its own location. For example, remote device 406 may include a GPS system so that it can include GPS location information (e.g., GPS coordinates) in a communication to an access system 402 and/or to a dispatch system such as central dispatch system 408. As another example, a remote device 406 may use a technique that involves triangulation (e.g., between base stations in a cellular network) to determine its location. Alternatively, another system such as a cellular network may use a technique that involves triangulation to determine the location of a remote device 406, and then send a location message to the remote device 406 to inform the remote device of its location. Other location-determination techniques are also possible.

In an illustrative arrangement, central dispatch system 408 may be a server or group of servers, which is configured to receive dispatch messages requests and/or dispatch instructions from an access system 402. Such dispatch messages may request or instruct the central dispatch system 408 to coordinate the deployment of UAVs to various target locations. A central dispatch system 408 may be further configured to route such requests or instructions to local dispatch systems 410. To provide such functionality, central dispatch system 408 may communicate with access system 402 via a data network, such as the Internet or a private network that is established for communications between access systems and automated dispatch systems.

In the illustrated configuration, central dispatch system 408 may be configured to coordinate the dispatch of UAVs 404 from a number of different local dispatch systems 410. As such, central dispatch system 408 may keep track of which UAVs 404 are located at which local dispatch systems 410, which UAVs 404 are currently available for deployment, and/or which services or operations each of the UAVs 404 is configured for (in the event that a UAV fleet includes multiple types of UAVs configured for different services and/or operations). Additionally or alternatively, each local dispatch system 410 may be configured to track which of its associated UAVs 404 are currently available for deployment and/or which services or operations each of its associated UAVs is configured for.

In some cases, when central dispatch system 408 receives a request for UAV-related service from an access system 402, central dispatch system 408 may select a specific UAV 404 to dispatch. The central dispatch system 408 may accordingly instruct the local dispatch system 410 that is associated with the selected UAV to dispatch the selected UAV. The local dispatch system 410 may then operate its associated deployment system 412 to launch the selected UAV. In other cases, a central dispatch system 408 may forward a request for a UAV-related service to a local dispatch system 410 that is near the location where the support is requested, and leave the selection of a particular UAV 404 to the local dispatch system 410.

In an example configuration, a local dispatch system 410 may be implemented in a computing system at the same location as the deployment system or systems 412 that it controls. For example, in some embodiments, a local dispatch system 410 could be implemented by a computing system at a building, such as a fire station, where the deployment systems 412 and UAVs 404 that are associated with the particular local dispatch system 410 are also located. In other embodiments, a local dispatch system 410 could be implemented at a location that is remote to its associated deployment systems 412 and UAVs 404.

Numerous variations on and alternatives to the illustrated configuration of UAV system 400 are possible. For example, in some embodiments, a user of a remote device 406 could request medical support directly from a central dispatch system 408. To do so, an application may be implemented on a remote device 406 that allows the user to provide information regarding a requested service, and generate and send a data message to request that the UAV system provide the service. In such an embodiment, central dispatch system 408 may include automated functionality to handle requests that are generated by such an application, evaluate such requests, and, if appropriate, coordinate with an appropriate local dispatch system 410 to deploy a UAV.

Further, in some implementations, some or all of the functionality that is attributed herein to central dispatch system 408, local dispatch system(s) 410, access system 402, and/or deployment system(s) 412 could be combined in a single system, implemented in a more complex system, and/or redistributed among central dispatch system 408, local dispatch system(s) 410, access system 402, and/or deployment system(s) 412 in various ways.

Yet further, while each local dispatch system 410 is shown as having two associated deployment systems, a given local dispatch system 410 may have more or less associated deployment systems. Similarly, while central dispatch system 408 is shown as being in communication with two local dispatch systems 410, a central dispatch system may be in communication with more or less local dispatch systems 410.

In a further aspect, a deployment system 412 may take various forms. In general, a deployment system may take the form of or include a system for physically launching a UAV 404. Such a launch system may include features that allow for a human-assisted UAV launch and/or features that provide for an automated UAV launch. Further, a deployment system 412 may be configured to launch one particular UAV 404, or to launch multiple UAVs 404.

A deployment system 412 may further be configured to provide additional functions, including for example, diagnostic related functions such as verifying system functionality of the UAV, verifying functionality of devices that are housed within a UAV (e.g., such as a defibrillator, a mobile phone, or an HMD), and/or maintaining devices or other items that are housed in the UAV (e.g., by charging a defibrillator, mobile phone, or HMD, or by checking that medicine has not expired).

In some embodiments, the deployment systems 412 and their corresponding UAVs 404 (and possibly associated local dispatch systems 410) may be strategically distributed throughout an area such as a city. For example, deployment systems 412 may be located on the roofs of certain municipal buildings, such as fire stations, which can thus serve as the dispatch locations for UAVs 404. Fire stations may function well for UAV dispatch, as fire stations tend to be distributed well with respect to population density, their roofs tend to be flat, and the use of firehouse roofs as leased spaces for UAV dispatch could further the public good. However, deployment systems 412 (and possibly the local dispatch systems 410) may be distributed in other ways, depending upon the particular implementation. As an additional example, kiosks that allow users to transport packages via UAVs may be installed in various locations. Such kiosks may include UAV launch systems, and may allow a user to provide their package for loading onto a UAV and pay for UAV shipping services, among other possibilities. Other examples are also possible.

In a further aspect, a UAV system 400 may include or have access to a user-account database 414. The user-account database 414 may include data for a number of user-accounts, and which are each associated with one or more person. For a given user-account, the user-account database 414 may include data related to or useful in providing UAV-related services. Typically, the user data associated with each user-account is optionally provided by an associated user and/or is collected with the associated user's permission.

Further, in some embodiments, a person may have to register for a user-account with the UAV system 400 in order to use or be provided with UAV-related services by the UAVs 404 of UAV system 400. As such, the user-account database 414 may include authorization information for a given user-account (e.g., a user-name and password), and/or other information that may be used to authorize access to a user-account.

In some embodiments, a person may associate one or more of their devices with their user-account, such that they can be provided with access to the services of UAV system 400. For example, when a person uses an associated mobile phone to, e.g., place a call to an operator of access system 402 or send a message requesting a UAV-related service to a dispatch system, the phone may be identified via a unique device identification number, and the call or message may then be attributed to the associated user-account. Other examples are also possible.

### IV. Illustrative Components of a UAV

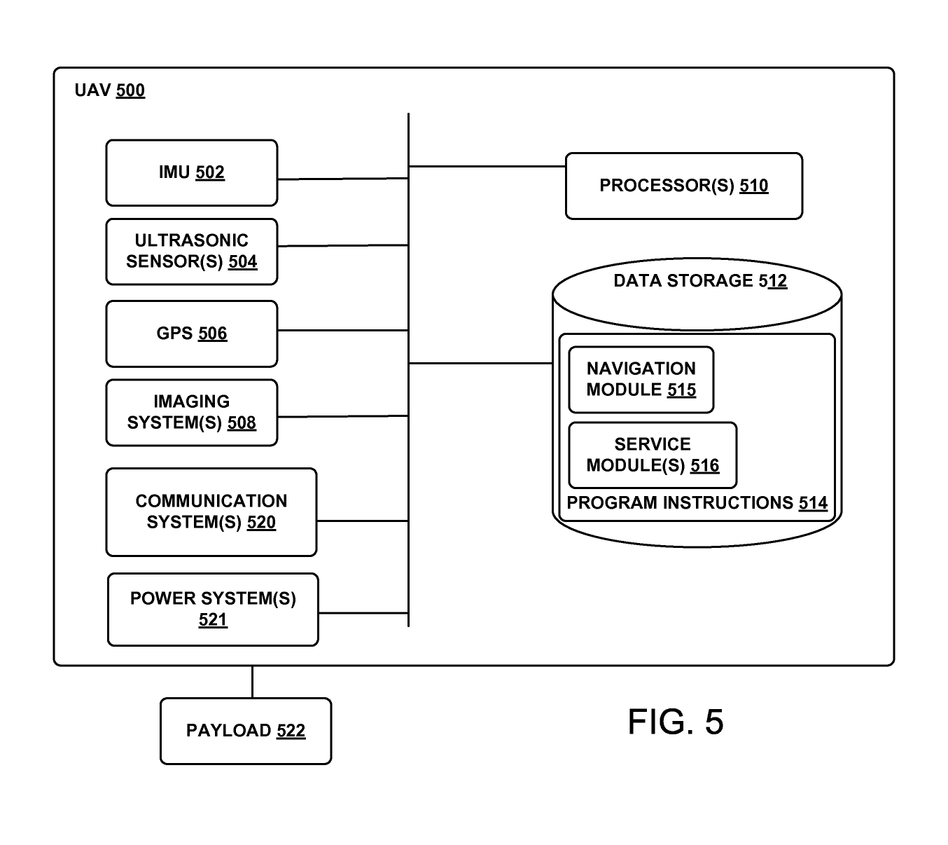

FIG. 5 is a simplified block diagram illustrating components of a UAV 500, according to an example embodiment. UAV 500 may take the form of or be similar in form to one of the UAVs 100, 200, 300, and 350 shown in FIGS. 1, 2, 3A, and 3B. However, a UAV 500 may also take other forms.

UAV 500 may include various types of sensors, and may include a computing system configured to provide the functionality described herein. In the illustrated embodiment, the sensors of UAV 500 include an inertial measurement unit (IMU) 502, ultrasonic sensor(s) 504, GPS 506, imaging system(s) 508, among other possible sensors and sensing systems.

In the illustrated embodiment, UAV 500 also includes one or more processors 510. A processor 510 may be a general-purpose processor or a special purpose processor (e.g., digital signal processors, application specific integrated circuits, etc.). The one or more processors 510 can be configured to execute computer-readable program instructions 514 that are stored in the data storage 512 and are executable to provide the functionality of a UAV described herein.

The data storage 512 may include or take the form of one or more computer-readable storage media that can be read or accessed by at least one processor 510. The one or more computer-readable storage media can include volatile and/or non-volatile storage components, such as optical, magnetic, organic or other memory or disc storage, which can be integrated in whole or in part with at least one of the one or more processors 510. In some embodiments, the data storage 512 can be implemented using a single physical device (e.g., one optical, magnetic, organic or other memory or disc storage unit), while in other embodiments, the data storage 512 can be implemented using two or more physical devices.

As noted, the data storage 512 can include computer-readable program instructions 514 and perhaps additional data, such as diagnostic data of the UAV 500. As such, the data storage 514 may include program instructions to perform or facilitate some or all of the UAV functionality described herein. For instance, in the illustrated embodiment, program instructions 514 include a navigation module 515 and one or more service modules 516.

### A. Sensors

In an illustrative embodiment, IMU 502 may include both an accelerometer and a gyroscope, which may be used together to determine the orientation of the UAV 500. In particular, the accelerometer can measure the orientation of the vehicle with respect to earth, while the gyroscope measures the rate of rotation around an axis. IMUs are commercially available in low-cost, low-power packages. For instance, an IMU 502 may take the form of or include a miniaturized MicroElectroMechanical System (MEMS) or a NanoElectroMechanical System (NEMS). Other types of IMUs may also be utilized.

An IMU 502 may include other sensors, in addition to accelerometers and gyroscopes, which may help to better determine position and/or help to increase autonomy of the UAV 500. Two examples of such sensors are magnetometers and pressure sensors. Other examples are also possible. (Note that a UAV could also include such additional sensors as separate components from an IMU.)

While an accelerometer and gyroscope may be effective at determining the orientation of the UAV 500, slight errors in measurement may compound over time and result in a more significant error. However, an example UAV 500 may be able mitigate or reduce such errors by using a magnetometer to measure direction. One example of a magnetometer is a low-power, digital 3-axis magnetometer, which can be used to realize an orientation independent electronic compass for accurate heading information. However, other types of magnetometers may be utilized as well.

UAV 500 may also include a pressure sensor or barometer, which can be used to determine the altitude of the UAV 500. Alternatively, other sensors, such as sonic altimeters or radar altimeters, can be used to provide an indication of altitude, which may help to improve the accuracy of and/or prevent drift of an IMU.

In a further aspect, UAV 500 may include one or more sensors that allow the UAV to sense objects in the environment. For instance, in the illustrated embodiment, UAV 500 includes ultrasonic sensor(s) 504. Ultrasonic sensor(s) 504 can determine the distance to an object by generating sound waves and determining the time interval between transmission of the wave and receiving the corresponding echo off an object. A typical application of an ultrasonic sensor for unmanned vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

UAV 500 also includes a GPS receiver 506. The GPS receiver 506 may be configured to provide data that is typical of well-known GPS systems, such as the GPS coordinates of the UAV 500. Such GPS data may be utilized by the UAV 500 for various functions. As such, the UAV may use its GPS receiver 506 to help navigate to the caller's location, as indicated, at least in part, by the GPS coordinates provided by their mobile device. Other examples are also possible.

UAV 500 may also include one or more imaging system(s) 508. For example, one or more still and/or video cameras may be utilized by a UAV 500 to capture image data from the UAV's environment. As a specific example, charge-coupled device (CCD) cameras or complementary metal-oxide-semiconductor (CMOS) cameras can be used with unmanned vehicles. Such imaging sensor(s) 508 have numerous possible applications, such as obstacle avoidance, localization techniques, ground tracking for more accurate navigation (e,g., by applying optical flow techniques to images), video feedback, and/or image recognition and processing, among other possibilities.

In a further aspect, UAV 500 may use its one or more imaging system 508 to help in determining location. For example, UAV 500 may capture imagery of its environment and compare it to what it expects to see in its environment given current estimated position (e.g., its current GPS coordinates), and refine its estimate of its position based on this comparison.

In a further aspect, UAV 500 may include one or more microphones. Such microphones may be configured to capture sound from the UAVs environment.

### B. Navigation and Location Determination

The navigation module 515 may provide functionality that allows the UAV 500 to, e.g., move about in its environment and reach a desired location. To do so, the navigation module 515 may control the altitude and/or direction of flight by controlling the mechanical features of the UAV that affect flight (e.g., rotors 110 of UAV 100).

In order to navigate the UAV 500 to a target location, a navigation module 515 may implement various navigation techniques, such as map-based navigation and localization-based navigation, for instance. With map-based navigation, the UAV 500 may be provided with a map of its environment, which may then be used to navigate to a particular location on the map. With localization-based navigation, the UAV 500 may be capable of navigating in an unknown environment using localization. Localization-based navigation may involve a UAV 500 building its own map of its environment and calculating its position within the map and/or the position of objects in the environment. For example, as a UAV 500 moves throughout its environment, the UAV 500 may continuously use localization to update its map of the environment. This continuous mapping process may be referred to as simultaneous localization and mapping (SLAM). Other navigation techniques may also be utilized.

In some embodiments, the navigation module 515 may navigate using a technique that relies on waypoints. In particular, waypoints are sets of coordinates that identify points in physical space. For instance, an air-navigation waypoint may be defined by a certain latitude, longitude, and altitude. Accordingly, navigation module 515 may cause UAV 500 to move from waypoint to waypoint, in order to ultimately travel to a final destination (e.g., a final waypoint in a sequence of waypoints).

In a further aspect, navigation module 515 and/or other components and systems of UAV 500 may be configured for “localization” to more precisely navigate to the scene of a medical situation. More specifically, it may be desirable in certain situations for a UAV to be close to the person to whom an item is being delivered by a UAV (e.g., within reach of the person). To this end, a UAV may use a two-tiered approach in which it uses a more-general location-determination technique to navigate to a target location or area that is associated with the medical situation, and then use a more-refined location-determination technique to identify and/or navigate to the target location within the general area.

For example, a UAV 500 may navigate to the general area of a person to whom an item is being delivered using waypoints. Such waypaints may be pre-determined based on GPS coordinates provided by a remote device at the target delivery location. The UAV may then switch to a mode in which it utilizes a localization process to locate and travel to a specific location of the person in need. For instance, if a person is having a heart attack at a large stadium, a UAV 500 carrying a medical package may need to be within reach of the person or someone near the person so that the can take items from the package. However, a GPS signal may only get a UAV so far, e.g., to the stadium. A more precise location-determination technique may then be used to find the specific location of the person within the stadium.

Various types of location-determination techniques may be used to accomplish localization of a person or a device once a UAV 500 has navigated to the general area of the person or device. For instance, a UAV 500 may be equipped with one or more sensory systems, such as, for example, imaging system(s) 508, a directional microphone array (not shown), ultrasonic sensors 504, infrared sensors (not shown), and/or other sensors, which may provide input that the navigation module 515 utilizes to navigate autonomously or semi-autonomously to the specific location of a person.

As another example, once the UAV 500 reaches the general area of a target delivery location (or of a moving subject such as a person or their mobile device), the UAV 500 may switch to a “fly-by-wire” mode where it is controlled, at least in part, by a remote operator, who can navigate the UAV 500 to the specific location of the person in need. To this end, sensory data from the UAV 500 may be sent to the remote operator to assist them in navigating the UAV to the specific location. For example, the UAV 500 may stream a video feed or a sequence of still images from the UAV's imaging system(s) 508. Other examples are possible.

As yet another example, the UAV 500 may include a module that is able to signal to a passer-by for assistance in either reaching the specific target delivery location; for example, a UAV may displaying a visual message requesting such assistance in a graphic display, play an audio message or tone through speakers to indicate the need for such assistance, among other possibilities. Such a visual or audio message might indicate that assistance is needed in delivering the UAV 500 to a particular person or a particular location, and might provide information to assist the passer-by in delivering the UAV 500 to the person or location (e.g., a description or picture of the person or location, and/or the person or location's name), among other possibilities. Such a feature can be useful in a scenario in which the UAV is unable to use sensory functions or another location-determination technique to determine the specific location of the person. However, this feature is not limited to such scenarios.

In some embodiments, once a UAV 500 arrives at the general area of a person who requested service and/or at the general area that includes a target delivery location, the UAV may utilize a beacon from a user's remote device (e.g., the user's mobile phone) to locate the person. Such a beacon may take various forms. As an example, consider the scenario where a remote device, such as the mobile phone of a person who requested a UAV delivery, is able to send out directional signals (e.g., an RF signal, a light signal and/or an audio signal). In this scenario, the UAV may be configured to navigate by “sourcing” such directional signals—in other words, by determining where the signal is strongest and navigating accordingly. As another example, a mobile device can emit a frequency, either in the human range or outside the human range, and the UAV can listen for that frequency and navigate accordingly. As a related example, if the UAV is listening for spoken commands, then the UAV could utilize spoken statements, such as “Help! I′m over here!” to source the specific location of the person in need of medical assistance.

In an alternative arrangement, a navigation module may be implemented at a remote computing device, which communicates wirelessly with the UAV. The remote computing device may receive data indicating the operational state of the UAV, sensor data from the UAV that allows it to assess the environmental conditions being experienced by the UAV, and/or location information for the UAV. Provided with such information, the remote computing device may determine altitudinal and/or directional adjustments that should be made by the UAV and/or may determine how the UAV should adjust its mechanical features (e.g., rotors 110 of UAV 100) in order to effectuate such movements. The remote computing system may then communicate such adjustments to the UAV so it can move in the determined manner.

### C. Communication Systems

In a further aspect, UAV 500 includes one or more communication systems 520. The communications systems 520 may include one or more wireless interfaces and/or one or more wireline interfaces, which allow UAV 500 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

In an example embodiment, a UAV 500 may include communication systems 520 that allow for both short-range communication and long-range communication. For example, the UAV 500 may be configured for short-range communications using Bluetooth and for long-range communications under a CDMA protocol. In such an embodiment, the UAV 500 may be configured to function as a “hot spot;” or in other words, as a gateway or proxy between a remote support device and one or more data networks, such as cellular network and/or the Internet. Configured as such, the UAV 500 may facilitate data communications that the remote support device would otherwise be unable to perform by itself.

For example, UAV 500 may provide a WiFi connection to a remote device, and serve as a proxy or gateway to a cellular service provider's data network, which the UAV might connect to under an LTE or a 3G protocol, for instance. The UAV 500 could also serve as a proxy or gateway to a high-altitude balloon network, a satellite network, or a combination of these networks, among others, which a remote device might not be able to otherwise access.

### D. Power Systems

In a further aspect, UAV 500 may include power system(s) 521. A power system 521 may include one or more batteries for providing power to the UAV 500. In one example, the one or more batteries may be rechargeable and each battery may be recharged via a wired connection between the battery and a power supply and/or via a wireless charging system, such as an inductive charging system that applies an external time-varying magnetic field to an internal battery.

### E. Payloads

A UAV 500 may employ various systems and configurations in order to transport items. In the illustrated embodiment, a payload 522 may serve as a compartment that can hold one or more items, such that a UAV 500 can deliver the one or more items to a target delivery location. For example, as shown in FIG. 1, a UAV 100 can include a compartment 135, in which an item or items may be transported. As another example, the UAV can include a pick-and-place mechanism, which can pick up and hold the item while the UAV is in flight, and then release the item during or after the UAV's descent. As yet another example, a UAV could include an air-bag drop system, a parachute drop system, and/or a winch system that is operable from high above a medical situation to drop or lower an item or items to the scene of the medical situation. Other examples are also possible. In some implementations, the payload 522 of a given UAV 500 may include or take the form of a “package” designed to transport medical-support items to a target delivery location. For example, a medical-support UAV may include a package with one or more items for medical support in the particular medical situation, and/or one or more medical-support modules 516 that are designed to provide medical support in the particular medical situation. In some cases, a UAV 500 may include a package that is designed for a particular medical situation such as choking, cardiac arrest, shock, asthma, drowning, etc. In other cases, a UAV 500 may include a package that is designed for a number of different medical situations, which may be associated in some way.

Such medical support items may aid in diagnosing and/or treating a person who needs medical assistance, or may serve other purposes. Example of medical-support items include, but are not limited to: (a) medicines, (b) diagnostic devices, such as a pulse oximeter, blood pressure sensor, or EKG sensor, (c) treatment devices, such as an EpiPen, a first aid kit, or various kinds of defibrillators (e.g., an automated external defibrillator (AED)), and/or (d) remote support devices, such as a mobile phone or a head-mountable device

(HMD), among other possibilities. Note that some items that are electronic may include one or more batteries to provide power to the item. These batteries may be rechargeable and may be recharged using one or more wired or wireless charging systems. In addition or on in the alternative, an item may be integrated with one or more batteries in the power system 521 for power.

In some embodiments, a UAV 500 could include an integrated system or device for administering or assisting in the administration of medical care (e.g., a system or device having one or more components that are built in to the structure of the UAV itself). For example, as noted above, a UAV could include an oxygen-therapy system. In an example configuration, an oxygen-therapy system might include a mask that is connected via tubing to an on-board oxygen source. Configured as such, the UAV could release the oxygen mask when it reaches a person in need of oxygen (e.g., at a fire scene).

As another example of a UAV with an integrated medical-support device, a UAV 500 might function as a mobile defibrillator. Specifically, rather than carry a stand-alone defibrillator that can then be removed from the UAV for use, the UAV itself may function as a defibrillator.

### F. Service Modules

As noted above, UAV 500 may include one or more service modules 916. The one or more service modules 516 include software, firmware, and/or hardware that may help to provide or assist in the provision of the UAV-related services.

Configured as such, a UAV 500 may provide various types of service. For instance, a UAV 500 may have stored information that can be provided to a person or persons at the target location, in order to assist the person or persons in various ways. For example, a UAV may include a video or audio file with instructions for performing some task, which the UAV can play out to a person at the target location. As another example, a UAV may include an interactive program to assist a person at the target location in performing some task. For instance, a UAV may include an application that analyzes the person's speech to detect questions related to the medical situation and/or that provides a text-based interface via which the person can ask such questions, and then determines and provides answers to such questions.

In some embodiments, a UAV 500 may facilitate communication between a layperson and/or medical personnel at the scene and medical personnel at a remote location. As an example, a service module 516 may provide a user interface via which a person at the scene can use a communication system 520 of the UAV to communicate with an emergency medical technician at a remote location. As another example, the UAV 500 can unlock certain capabilities of a remote device, such as a mobile phone, which is near the UAV at the scene of a medical situation. Such capabilities may be inaccessible to a user of the remote device, unless the remote device is within a certain distance from the UAV such that the UAV can unlock the capabilities. For example, a UAV may send the remote device a security key that allows the remote device to establish a secure connection to communicate with medical personnel at a remote location. Other examples are also possible.

### V. Example Power Management System

As mentioned above, example embodiments may relate to methods and systems for supplying auxiliary power to an unmanned aerial vehicle (UAV) with different flight modes.

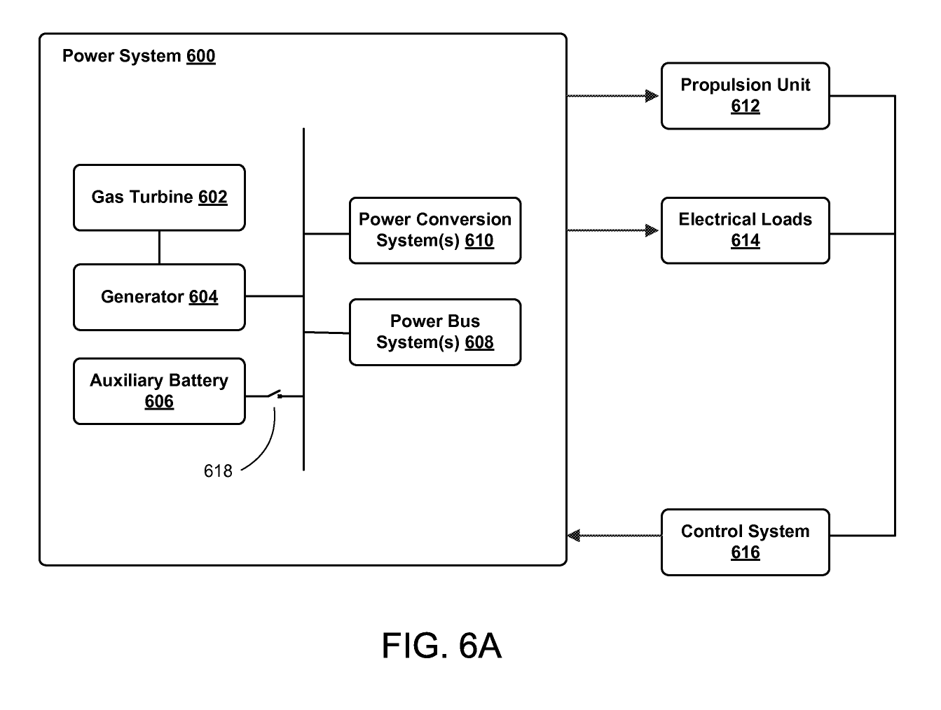

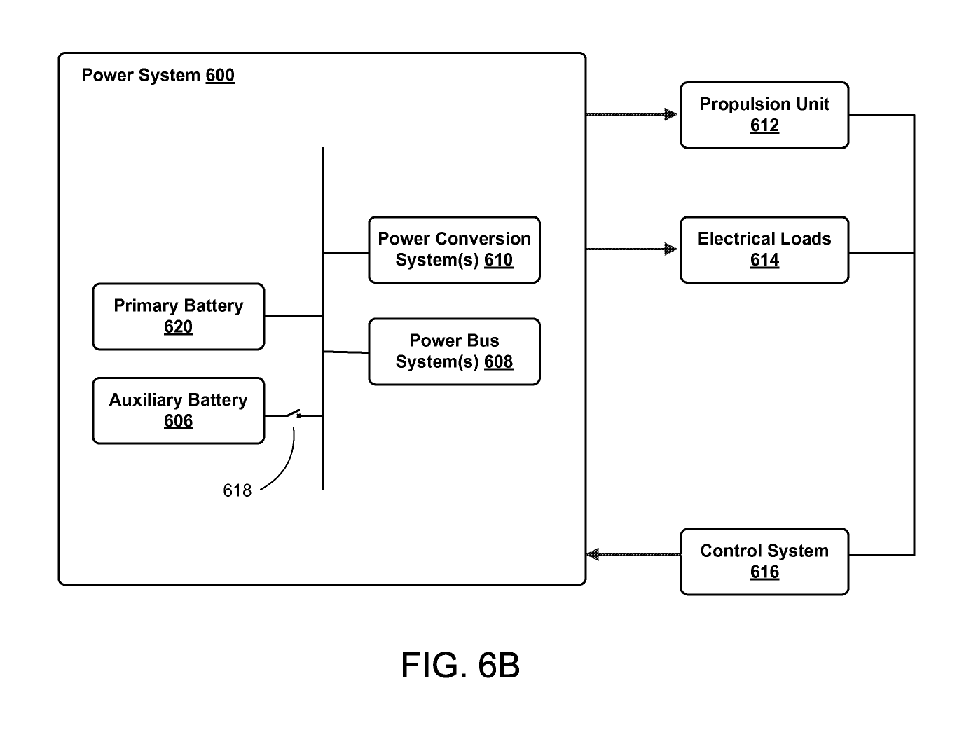

Consider FIG. 6A showing an example power system 600 configured to supply power to a UAV, which may take a form such as described in association with FIGS. 1, 2, 3A, 3B, 4, and 5, or may take another form. Power system 600 may be configured to operate in the same or in a similar manner as the power system 521 discussed above in association with FIG. 5. However, power system 600 may be configured to operate in any manner and may be positioned anywhere on a UAV.

As shown in FIG. 6A, power system 600 includes a gas turbine 602 coupled to a generator 604, an auxiliary battery 606, one or more power bus system(s) 608, and one or more power conversion system(s) 610. The power system 600 is shown for illustration purposes only and may include additional components and/or have one or more components removed. Additionally, the components of the power system 600 may be arranged and connected in any manner. Other examples and combination may also be possible without departing from the scope of the invention.

As further shown in FIG. 6A, power system 600 may be configured to supply power to a propulsion unit 612 and/or other electrical loads 614 in a UAV. In one example, a propulsion system 612 may include rotors 110 of multicopter 100 as discussed above in association with FIG. 1. More specifically, each rotor 110 may include blades that are attached to a motor 120. In another example, a propulsion system 612 may include the operating propellers 206 of the tail-sitter UAV 200 as discussed above in association with FIG. 2. In yet another example, propulsion system 612 may include the propulsion unit 312 of fixed-wing aircraft 300, which may include a motor, shaft, and propeller as discussed above in association with FIG. 3A. In yet another example, propulsion system 612 may include the propulsion unit 358 of aircraft 350, which may include a motor, shaft, and propeller as discussed above in association with FIG. 3A. Other examples and combination of propulsion systems included in a UAV may also be possible.

As mentioned above, power system 600 may supply power to other electrical loads 614 in a UAV. Such electrical loads 614 may include, for example: inertial measurement unit (IMU) 502, ultrasonic sensor(s) 504, GPS 506, imaging system 508, processor(s) 510, data storage 512, and communication system(s) 520, among other possibilities.

In an example embodiment, a control system 616 may communicate with the power system 600, the propulsion unit 612, electrical loads 614, a remote-controller and/or other components in a UAV. For example, the control system 616 may be configured to receive information from the propulsion unit 612 and the electrical loads 614 that includes power requirements at any given point in time during a UAV's operation. The control system 616 may then responsively send instruction to the power system 600 to supply the power required at that point in time. Additionally, as will be further discussed below, the control system 616 may be configured to send instruction to the power system 600 that include a selection of the power sources to be used at various times during a UAV's operation. Further, note that the control system 616 may take on any configuration and may be located anywhere in a UAV. Components of power system 600 will now be discussed in more detail.

As mentioned above, gas turbine 602 may be coupled to a generator 604 in order to supply power to the UAV, where the gas turbine 602 may be the primary power source for the UAV. A gas turbine 602 is a type of internal combustion engine (ICE), which may be configured as a rotary engine that extracts energy from a flow of combustion gas and converts the energy to useful mechanical energy. In one case (not shown), the gas turbine 602 may be directly coupled to the propulsion system 612 such that the mechanical energy is directly transferred to the propulsion system 612 (e.g., to the propeller/blades) thus allowing the UAV to achieve forward thrust or achieve hover flight. Note that other types of ICEs may also be used.

In another case, the gas turbine 602 may be coupled to the generator 604 as shown in FIG. 6A. The generator 604 may be configured to convert the mechanical energy generated by the gas turbine 602 into electricity (i.e., electrical energy) used to power the UAV. In particular, the electrical energy from the generator 604 may be used to supply power to the propulsion unit 612 and/or the other electrical loads 614. More specifically, the electrical energy may be supplied to a motor that may be a part of the propulsion unit 612, where the motor may convert the electrical energy into mechanical energy that may be transferred to, for example, a propeller via a shaft and a gear box. Other engine configurations may also be possible. Additionally, note that the gas turbine 602 may also be referred to as a gas engine or a jet engine, among other possibilities.

As mentioned above, the power system 600 may include an auxiliary battery 606 configured to supplement power to the UAV in addition to the primary power source (e.g., gas turbine 602). However, in some cases, the auxiliary battery 606 may become the primary power source rather than providing supplemental power. The auxiliary battery 606 may be any type of battery such as a lithium ion battery, lithium polymer battery, or a nickel cadmium battery, among others. A battery type to be used as an auxiliary power source may be selected based on various factors such as cost and utilization for higher power draws, among others.

The auxiliary battery 606 may be activated and deactivated at any time as demonstrated by switch 618. In particular, activation and deactivation of the auxiliary battery 606 may be based on instructions received from the control system 616 as discussed above. Note that the primary power source (e.g., gas turbine 602) may also be activated and deactivated based on instructions received from the control system 616. Other examples may also be possible.

In an example embodiment, power system 600 may include one or more power bus system(s) 608 configured to receive power from the power sources described herein and manage distribution of the power throughout the UAV. In one example, the power bus system(s) 608 may include an AC power bus connected to power sources that are configured to generate AC power (e.g., gas turbine 602 in conjunction with generator 604). The AC power bus may be connected to electrical loads that need AC power for operation. Alternatively, the AC power bus may supply the power to a power conversion system 610 such as an AC/DC converter. The AC/DC converter may then be connected to electrical loads that need DC power for operation.

In another example, additionally or alternatively, the power bus system(s) 608 may include a DC power bus connected to power sources that are configured to generate DC power (e.g., auxiliary battery 606). The DC power bus may then be connected to electrical loads that need DC power for operation. Alternatively, the DC power bus may supply the power to a power conversion system 610 such as a DC/AC converter. The DC/AC converter may then be connected to electrical loads that need AC power for operation.

In some cases, a power conversion system 610 may include a DC-to-DC converter that may be connected between a DC power source and the DC power bus or between the DC power bus and DC electrical loads, among other possibilities. Such a DC-to-DC converter may be used to adjust a voltage supplied to a load. Additionally, the operation of the power bus system(s) 608 and power conversion system(s) 610 may be configured based on instructions received from the control system 616. Other examples, configurations, and combinations of power bus system(s) 608 and power conversion system(s) 610 may also be possible.

In an example embodiment, a battery may be used as the primary power source instead of the gas turbine 602. In this case, power system 600 may include two batteries rather than a gas turbine 602 and an auxiliary battery 606. To illustrate, consider FIG. 6B showing the power system 600 as first presented in FIG. 6A, where a primary battery 620 replaces the gas turbine 602 and the generator 604 as the primary power source. The primary battery 620 and the auxiliary battery 606 may be of the same battery type (e.g., of the same battery chemistry). Alternatively, batteries 620 and 606 may be of different battery types. An additional discussion of battery types is presented below.

While FIGS. 6A and 6B show the power system 600 as including two power sources, the power system 600 may include any number of power sources. Additionally, multiple power sources may be used in any combination during any phase of the UAV's flight. Further, the primary power source and the auxiliary power source may be placed on the UAV in any configuration. For example, the UAV may have a single set of rotors with the multiple power sources positioned on a single powertrain. Yet further, other power sources and/or energy storage components may also be used. For example, alternative energy systems such as wind power and solar power may also be used as auxiliary and/or primary power sources for the UAV. Other configurations, examples and combinations may also be possible

### VI. Illustrative Methods

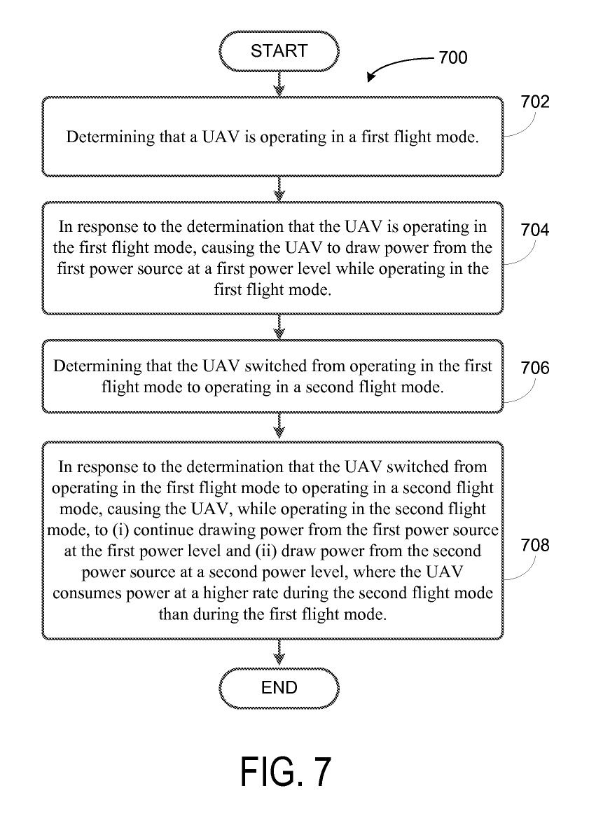

FIG. 7 is a flow chart illustrating a method 700, according to an example embodiment. Illustrative methods, such as method 700, may be carried out in whole or in part by a component or components in a UAV, such as by the one or more of the components of the multicopter 100 shown in FIG. 1, by the one or more of the components of the tail-sitter UAV 200 shown in FIG. 2, by the one or more of the components of the fixed-wing aircraft 300 shown in FIG. 3A, and by the one or more of the components of the aircraft 350 shown in FIG. 3B. Additionally, method 700 may be carried out in whole or in part by one or more components of UAV system 400, UAV 500, power system 600, and/or control system 616. However, it should be understood that example methods, such as method 700, may be carried out by other entities or combinations of entities (i.e., by other computing devices and/or combinations of computing devices), without departing from the scope of the invention.

As shown by block 702, method 700 involves determining that a UAV is operating in a first flight mode.

In an example embodiment, a UAV's flight modes may include a forward-flight mode (e.g., the first flight mode). In forward flight, the UAV may generate forward thrust by pushing air in the direction opposite to the direction of flight. In particular, forward flight may be the part of aircraft travel that is most energy efficient. More specifically, forward-flight mode may occur between ascent and descent phases of flight and may encompass a majority (e.g., 90%) of a UAV's flight.

Forward flight of a UAV may involve flight dynamics similar to an airplane where a fixed-wing aircraft is propelled forward by thrust from a jet engine or a propeller. For instance, as mentioned above, FIG. 2 shows an example of a tail-sitter UAV 200. In the illustrated example, the tail-sitter UAV 200 has fixed wings 202 to provide lift and allow the UAV to glide horizontally such that the UAV 200 is in a forward-flight mode. In particular, when the UAV 200 is positioned horizontally, the propellers 206 may provide forward thrust so that the tail-sitter UAV 200 can fly in a similar manner as a typical airplane.

In another instance, as mentioned above, FIG. 3A shows an example of a fixed-wing aircraft 300 that has stationary wings 302 that generate lift based on the wing shape and the vehicle's forward airspeed such that aircraft 300 may be configured to fly in a forward-flight mode. In yet another instance, as mentioned above, FIG. 3B shows an example of an aircraft 350 with a propeller in a pusher configuration that allows aircraft 350 to fly in a forward-flight mode. The term “pusher” refers to the fact that the propulsion unit 358 is mounted at the back of the aircraft and “pushes” the vehicle forward, in contrast to the propulsion unit being mounted at the front of the aircraft. Other examples UAVs with a forward-flight mode may also be possible.

As shown by block 704, method 700 involves, in response to the determination that the UAV is operating in the first flight mode, causing the UAV to draw power from the first power source at a first power level while operating in the first flight mode.

In an example embodiment, a control system in a UAV may determine that the UAV is operating in forward-flight mode. For instance, as mentioned above, control system 616 may receive information from the propulsion unit 612, processor 510, and/or other electrical loads 614. The received information may include an indication of the UAV's current flight mode as well as information related to power requirements, payload on the UAV (e.g., payload 522), weight of the UAV, flight distance to a destination, flight conditions, and flight speed, among other possibilities.

In response to determining that the UAV is operating in forward-flight mode, the control system 616 may send instructions to the power system 600 to cause the UAV to draw power from a primary power source (e.g., the first power source) such as the gas turbine 602 shown in FIG. 6A or the primary battery 620 shown in FIG. 6B. In particular, the instruction may specify a power level (e.g., the first power level) at which the UAV may draw power from the primary power source. As a result, the primary power source may then be configured to provide the specified power level while the UAV is operating at the forward-flight mode.

As mentioned above, forward flight may encompass a majority (e.g., 90%) of a UAV's flight and may be the part of aircraft travel that is most energy efficient. As such, it may be advantageous to optimize the primary power source to provide power at a constant power level during forward flight. Optimization of the constant power level may be predetermined, may be determined prior to takeoff, and/or may be determined prior to operating in forward-flight mode, among other possibilities. The constant power level may be specified in terms of wattage, voltage, or current, among others.

The constant power level may be optimized based one or more factors. For instance, the constant power level may be optimized based on flight speed of the UAV. In particular, the flight speed may be a projected flight speed that may be determined prior to operation in forward-flight mode. The flight speed may be determined based on factors such as flight distance, flight conditions, weight of the UAV, and payload on the UAV, among other possibilities. For example, the system (e.g., a processor) may determine the power requirement of the UAV for each phase of the flight path to a particular destination based on the factors listed above. Consequently, the system may optimize the constant power level to be drawn from the primary power source while the UAV operate at forward-flight mode at various phases of the flight path.

In another example, as further discussed below, an auxiliary power source may be used to provide a boost of power in certain phases of flight (such as hover-flight mode) that result in higher power draws. Additionally, an auxiliary power source may also be desirable to avoid damage to the primary power source of the UAV. As a result, the constant power level may be optimized based on the capacity of the primary and auxiliary power sources to provide power such that operational longevity of the primary power source is increased. For example, statistical data involving lifetime of a power source based on power utilization over time may be used to optimize the constant power level drawn from the primary power source while the UAV operate at forward-flight mode. Other examples may also be possible.

In yet another example, flight history may be used to optimize the constant power level. For instance, the flight history may include the flight speed during previous flights, flight distance during previous flights, flight conditions during previous flights, weight of the UAV during previous flights, and/or payload on the UAV during previous flights, among other possibilities. Additionally, the flight history may also include previous power levels used during previous flights as well as the associated factors used to select the power levels.

In yet another example, optimization may be based upon a model of the UAV and a simulation of the flight mission. In some cases, the simulation may be performed during the UAV's flight in order to update a power use plan for emergency conditions, such as a change in wind. For example, a simulated flight with optimal power usage may be planned at takeoff. However, during flight, an issue with the vehicle hardware (e.g., damage or trim errors) or an environmental change (e.g., a change in altitude density or wind direction/speed) may lead to a change of the optimal power usage. As such, model predictive control may allow for continuously updating the power use plan to deal with unexpected issues.

More specifically, the simulation may use models of the flight vehicle (e.g., UAV) and models of the power systems (e.g., including power source lifetimes). For example, a characterization of the variance of a power sources lifetime and capacity may allow both an optimization of expected lifetime and a confidence number (e.g., 95%) to be computed, thereby improving reliability by avoiding cases where sources may be over-taxed or completely drained. As a result, the probability of an auxiliary source failing during a flight may be computed and minimized.

In yet another example, optimization of power use may be based on the mission profile. For instance, in some cases the UAV may only need to hover in a non-fixed position (e.g., a “relatively loose” position such as while providing telecommunications networking support at high altitude). In this case, the system may determine that the UAV can be powered by the first power supply for a majority of the mission because it may not be necessary to hold a fixed position during hover flight. In contrast, some cases may result in a need for the UAV to hold a (relatively) fixed position during hover flight (e.g., delivering a package low to the ground). In such cases, the system may determine that a boost of power may be needed to allow for control of the UAV at a (relatively) fixed position, thereby activating the second power source.

In yet another case, the system may take environmental factors into account for system optimization and operation of the power sources. For example, if the UAV's flight path occurs over an area that requires noise reduction (e.g., a suburban neighborhood at night), the system may activate a quieter power source (e.g., even if efficiency is reduced). However, if no noise reduction is necessary then the system may optimize based on efficient. Other examples may also be possible.

As shown by block 706, method 700 involves determining that the UAV switched from operating in the first flight mode to operating in a second flight mode.

In an example embodiment, a UAV may be configured to transition to a second flight mode such as a hover-flight mode, where flight dynamics may be similar to a helicopter. More specifically, in hover-flight mode, lift and thrust may be supplied by rotors that allow the UAV to take off and land vertically and fly in all directions.

For instance, as mentioned above, FIG. 1 shows four rotors 110 that provide propulsion and maneuverability for the multicopter 100 and therefore allow the multicopter 100 to fly in a hover-flight mode. More specifically, each rotor 110 includes blades that are attached to a motor 120. Configured as such the rotors may allow the multicopter 100 to take off and land vertically, to maneuver in any direction, and/or to hover.

In another instance, referring back to FIG. 2 showing an example of a tail-sitter UAV 200, the fixed wings 202 also allow the tail-sitter UAV 200 take off and land vertically on its own. For example, as mentioned above, tail-sitter UAV 200 may be positioned vertically (as shown) with fins 204 and/or wings 202 resting on the ground and stabilizing the UAV in the vertical position. The tail-sitter UAV 200 may then operate in a hover-flight mode and take off by operating propellers 206 to generate the upward thrust (e.g., a thrust that is generally along the y-axis). Other examples UAVs with a hover-flight mode may also be possible.

Additional examples of a second flight mode may include other phases of flight (or maneuvers) that result in a higher power draws (e.g., higher power draws than forward-flight mode) such as acceleration, turning, climbing in altitude, stopping at hover, takeoff, and landing, among other possibilities.

As shown by block 708, method 700 involves, in response to the determination that the UAV switched from operating in the first flight mode to operating in a second flight mode, causing the UAV, while operating in the second flight mode, to (i) continue drawing power from the first power source at the first power level and (ii) draw power from the second power source at a second power level, where the UAV consumes power at a higher rate during the second flight mode than during the first flight mode.

Typically, the longer a flight is, the larger the portion of the flight that is spent in forward-flight mode (and correspondingly, the smaller the portion of the flight that is spent in hover-flight mode). However, hover-flight mode may involve a higher power requirement than forward-flight mode because a significant portion of the required lift in forward flight may be generated via the wing rather than directly via thrust. In particular, hover flight may result in a higher power draw (e.g., peak power consumption lasting for a specific time period) than forward flight. In this case, a single power source may not be enough to withstand such a power draw.

As mentioned above, an auxiliary power source (e.g., the second power source) may be desirable to provide a boost of power in certain phases of flight (such as hover-flight mode) that result in higher power draws. Additionally, an auxiliary power source may also be desirable to avoid damage to the primary power source of the UAV. For example, higher power draws for batteries with certain chemistries may result in damage and/or a shorter life span for the battery and may therefore require frequent replacement of the primary power source. As a result, having a smaller and easily replaceable auxiliary power source for higher power draws may reduce the cost of replacement.

In other words, the UAV may include at least one primary power source, which may be used during the UAV's flight modes that involve lower power draws (e.g. forward-flight mode), and may include at least one auxiliary power source, which may be used to supplement (and/or replace) the primary power source during phases of flight that involve higher power draws. This may help to prevent damage to the primary power source.

In an example embodiment, the primary power source and the auxiliary power source may be different power sources such as a gas engine and a battery (as shown in FIG. 6A) or two different batteries (as shown in FIG. 6B). In one example, a gas engine may be used as the primary power source for forward-flight mode and a battery may be used as an auxiliary power source for hover-flight mode. Such a configuration may take advantage of the different specific energy densities of fuel versus batteries due to gas's higher specific energy density.

In another example, a battery with a specific type of chemistry (e.g., Lithium Ion or Lithium Polymer) may be used as the primary power source for forward-flight mode. In particular, a battery type to be used as the primary power source may be selected based on various factors such as efficiency and weight, among others. A battery with a different type of chemistry (e.g., Nickel Cadmium) may then be used as the auxiliary power source for hover-flight mode. In particular, a battery type to be used as the auxiliary power source may be selected based on various factors such as cost and utilization for higher power draws, among others. In another case, batteries of the same type may be used. Other combinations of power sources may also be possible.

The auxiliary power source may be activated and deactivated at any time during a UAV's flight. In particular, the auxiliary power source may be activated and deactivated directly or via a switch (e.g., switch 618), among other possibilities. For instance, the auxiliary power source may be deactivated (e.g., powered off) while the UAV is operating in forward flight. In another instance, the auxiliary power source may operate at a reduced power level while the UAV operates in a forward-flight mode. However, the auxiliary power source may be configured to supply any level of power at any phase of a UAV's flight.

In an example embodiment, as mentioned above, the auxiliary power source may be activated to provide a boost of power in certain phases of flight (such as hover-flight mode) that result in higher power draws. In particular, the UAV may continue drawing power from the primary power source at the constant optimized power level while the UAV is operating in hover-flight mode. Additionally, the UAV may also draw power from the second power source at a determined power level. The power level drawn from the auxiliary power source may be determined based on the power requirements of the UAV.

For example, a power requirement for the UAV during a particular point in time during hover-flight mode may be 150 Watts. If the optimized constant power level for the primary power source is 100 Watts, then the auxiliary power source may be configured to supply 50 Watts of power. Additionally, the power drawn from the auxiliary power source may be adjusted as the power requirement changes during hover-flight mode (or any other mode with higher power draws). For instance, if the power requirement for the UAV during a later point in time during hover-flight mode changes to 120 Watts, then the auxiliary power source may be configured to supply 20 Watts of power.

An auxiliary power source may be selected with a particular maximum power output such that the primary power source does not need to compensate for the auxiliary power source during high power draws. However, in some cases, the auxiliary power source may have a maximum amount of power such that the primary power source may need to compensate for the auxiliary power source during high power draws. In this case, the primary power source (or an additional third power source) may be configured to compensate for the remaining power that is needed based on power requirements.

For example, the primary power source may be configured to supply maximum power of 150 Watts while the auxiliary power source may be configured to supply maximum power of 60 Watts. However, the optimized constant power level for the primary power source may be determined as 90 Watts. If a power requirement for the UAV during a particular point in time during hover-flight mode is 180 Watts, then the auxiliary power source may be configured to supply the maximum power of 60 Watts while the primary power source may be configured to stop the supply of optimized constant power level and compensate by providing 120 Watts of power (i.e., provide additional 30 Watts of power). Alternatively, a third power source may be configured to compensate for the 30 Watts needed to meet the power requirement. Other examples may also be possible.

In some cases, activation of the auxiliary power source may be determined based on a location of the UAV. For instance, control system 616 may receive an indication from GPS 506 that the UAV is a particular distance away from a destination. In response to such an indication, the control system 616 may determine that the UAV is going to switch to a hover-flight mode when the UAV is proximate to the destination. As a result, the control system 616 may send instructions to the power system 600 to activate the auxiliary power source when the UAV is a predetermined distance away from the destination. Other examples may also be possible.

In an example embodiment, the system (e.g., the control system) may determine that the UAV switched from operating in a mode with high power draw, such as hover-flight mode, to an operating mode with a lower power draw, such as forward-flight mode. In this case, the system may deactivate the auxiliary power source while maintaining operation of the primary power source at the optimized constant power level. Alternatively, the system may reduce the power output of the auxiliary power source. Other examples may also be possible.

### VII. Conclusion

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A system comprising:
a first power source for an unmanned aerial vehicle (UAV);
a second power source configured to supply auxiliary power for the UAV; and
a control system configured to:
determine that the UAV is operating in a first flight mode, and responsively cause the UAV to draw power from the first power source at a first power level while operating in the first flight mode;
determine that the UAV has switched from operating in the first flight mode to operating in a second flight mode; and
upon determining that the UAV has switched from operating in the first flight mode to operating in the second flight mode, cause the UAV to continue drawing power from the first power source at the first power level and to draw power from the second power source at a second power level, wherein the UAV consumes power at a higher rate during the second flight mode than during the first flight mode.

2. The system of claim 1, wherein the control system is further configured to:
determine that the UAV has switched from operating in the second flight mode to operating in the first flight mode; and
upon determining that the UAV switched from operating in the second flight mode to operating in the first flight mode, deactivate the second power source and maintain operation of the first power source at the first power level.

3. The system of claim 1, wherein the first power level is an optimized constant power level.

4. The system of claim 3, wherein the optimized constant power level is determined based on one or more of: (i) payload on the UAV, (ii) weight of the UAV, (iii) flight distance, (iv) flight conditions, and (v) flight speed.

5. The system of claim 1, wherein the second power source is powered off while the UAV operates in the first flight mode.

6. The system of claim 1, wherein the second power source is operated at a reduced power level while the UAV operates in the first flight mode, and wherein the reduced power level is lower than the second power level.

7. The system of claim 1, wherein the first flight mode comprises forward flight.

8. The system of claim 1, wherein the second flight mode comprises hover flight.

9. The system of claim 1, wherein the second flight mode comprises one or more of: (i) acceleration, (ii) turning, (iii) climbing in altitude, (iv) stopping at hover, (v) takeoff, and (vi) landing.

10. The system of claim 1, wherein the first power source comprises a first specific energy density, wherein the second power source comprises a second specific energy density, and wherein the first specific energy density is higher than the second specific energy density.

11. The system of claim 1, wherein the first power source comprises an internal combustion engine, and wherein the second power source comprises a battery.

12. The system of claim 1, wherein the first power source comprises a first battery, and wherein the second power source comprises a second battery.

13. The system of claim 12, wherein the first and second batteries comprise the same battery type.

14. The system of claim 12, wherein the first and second batteries comprise different battery types.

15. The system of claim 1, wherein the first and second power sources are configured to operate on the same powertrain.

16. A method comprising:
determining that a UAV is operating in a first flight mode;
in response to the determination that the UAV is operating in the first flight mode, causing the UAV to draw power from the first power source at a first power level while operating in the first flight mode;
determining that the UAV has switched from operating in the first flight mode to operating in a second flight mode; and
in response to determining that the UAV has switched from operating in the first flight mode to operating in the second flight mode, causing the UAV to continue drawing power from the first power source at the first power level and to draw power from the second power source at a second power level, wherein the UAV consumes power at a higher rate during the second flight mode than during the first flight mode, and wherein the power draw from the second power source at the second power level begins upon determining that the UAV has switched to operating in the second flight mode.

17. The method of claim 16, further comprising:
determining that the UAV has switched from operating in the second flight mode to operating in the first flight mode; and
in response to determining that the UAV has switched from operating in the second flight mode to operating in the first flight mode, deactivating the second power source and maintaining operation of the first power source at the first power level, wherein deactivating the second power source occurs upon determining that the UAV has switched from operating in the second flight mode to operating in the first flight mode.

18. The method of claim 16, wherein the first power level is an optimized constant power level.

19. The method of claim 16, wherein the optimized constant power level is determined based on one or more of: (i) payload on the UAV, (ii) weight of the UAV, (iii) flight distance, (iv) flight conditions, and (v) flight speed.

20. A non-transitory computer readable medium having stored therein instructions executable by a control system to cause the control system to perform functions comprising:
determining that a UAV is operating in a first flight mode;
in response to the determination that the UAV is operating in the first flight mode, causing the UAV to draw power from the first power source at a first power level while operating in the first flight mode;
determining that the UAV has switched from operating in the first flight mode to operating in a second flight mode; and
in response to determining that the UAV has switched from operating in the first flight mode to operating in the second flight mode, causing the UAV to continue drawing power from the first power source at the first power level and to draw power from the second power source at a second power level, wherein the UAV consumes power at a higher rate during the second flight mode than during the first flight mode, and wherein the power draw from the second power source at the second power level begins upon determining that the UAV has switched to operating in the second flight mode.
